(19) United States
(12) Patent Application Publication
(10) Pub. No.: US 2011/0209217 A1
(43) Pub. Date: Aug. 25, 2011

(54) INFORMATION PROCESSING APPARATUS, INFORMATION PROCESSING METHOD, AND PROGRAM

(75) Inventors: Seiji MIYAMA, Kanagawa (JP); Yuji MATSUYAMA, Tokyo (JP); Tsugutomo ENAMI, Saitama (JP); Atsushi MITSUZAWA, Kanagawa (JP); Hiroshi KAWASHIMA, Tokyo (JP)

(73) Assignee: Sony Corporation, Tokyo (JP)

(21) Appl. No.: 13/018,626

(22) Filed: Feb. 1, 2011

(30) Foreign Application Priority Data
Feb. 19, 2010 (JP) 2010-034914

(51) Int. Cl. G06F 21/00

(52) U.S. Cl. 726/22

(57) ABSTRACT

There is provided a PC including a guest OS group which manages a group including an OS executed in an office, an information-management section which manages communication capability information which is set to communication-capable information or communication-incapable information, a being-inside-office determination processing section which determines whether or not the PC is used in the office, which sets the communication capability information to the communication-capable information when the being-inside-office determination processing section determines that the PC is used in the office, and which sets the communication capability information to the communication-incapable information when the being-inside-office determination processing section determines that the PC is not used in the office, and a communication control section which controls communication with another device performed by an OS execution section which executes the OS included in the group based on the communication capability information.

### BACKGROUND OF THE INVENTION

1. Field of the Invention

The present invention relates to an information processing apparatus, an information processing method, and a program.

2. Description of the Related Art

In recent years, with the spread of PCs (Personal Computers), cases of using PCs not only at work for the purpose of working but at home after coming back from work for private use have increased. In addition, since the weight of a PC has been reduced, there are more cases of bringing a PC used at work back home and using the PC at home, and more cases of bringing a PC which is brought back and used at home to the work and using the PC at work. In this way, it is becoming more common to bring a PC which has been used in one environment to another environment and to use the PC.

For example, in the case of bringing a PC used at work back home and using the PC at home, important data may be stored in the PC at work, and the PC may be connected to a network such as the Internet when back at home. In such a case, the important data stored in the PC is exposed to the risk of being leaked via the Internet.

Further, for example, in the case of bringing a PC, which is brought back and used at home, to the work and using the PC at work, the PC may be infected with a virus at home via a network such as the Internet, and the PC may be connected to an in-company intranet after arriving for work. In such a case, there may be a risk of the virus with which the PC is infected being spread via the intranet in the office. In order to protect the PC from the virus infection, there are disclosed various kinds of technology (for example, refer to JP-A-2006-178936).

In this way, when an information processing apparatus such as a PC used in one environment is brought to and used in another environment, the information processing apparatus may be exposed to various risks.

### SUMMARY OF THE INVENTION

According to the technology disclosed in JP-A-2006-178936, although the risk of the information processing apparatus becoming infected with a virus can be lowered, there was an issue that it was difficult to lower the risk that the information processing apparatus was exposed to, which was caused by changing the environment of using the information processing apparatus.

In light of the foregoing, it is desirable to provide a novel and improved technology which is capable of lowering the risk that the information processing apparatus is exposed to, which is caused by changing the environment of using the information processing apparatus.

According to an embodiment of the present invention, there is provided an information processing apparatus which includes a first environment group information-management section which manages a first environment group including an operating system executed in a first environment, a communication information-management section which manages first communication capability information which is set to communication-capable information indicating that communication with another device is possible or communication-incapable information indicating that the communication with such another device is not possible, a determination processing section which determines at a predetermined timing whether or not the information processing apparatus is used in the first environment, which sets the first communication capability information managed by the communication information-management section to the communication-capable information when the determination processing section determines that the information processing apparatus is used in the first environment, and which sets the first communication capability information managed by the communication information-management section to the communication-incapable information when the determination processing section determines that the information processing apparatus is not used in the first environment, and a communication control section which controls communication with such another device performed by an operating system execution section which executes the operating system included in the first environment group, based on the first communication capability information managed by the communication information-management section.

The information processing apparatus may further include a determination information-management section which manages, when a connection request is received from a device used in the first environment, determination server-identification information for identifying a determination server that establishes a connection with the device. The determination processing section may transmit a connection request to the determination server identified by the determination server-identification information managed by the determination information-management section, may determine that the information processing apparatus is used in the first environment when a connection with the determination server is established, and may determine that the information processing apparatus is not used in the first environment when the connection with the determination server is not established.

The information processing apparatus may further include a determination information-management section which manages first internal gateway device-identification information for identifying a first internal gateway device that is present in the first environment and first external gateway device-identification information for identifying a first external gateway device that is present in a predetermined environment other than the first environment. When the determination processing section transmits a routing information-acquiring packet to an external device that is present in the predetermined environment other than the first environment, and a response packet with respect to the routing information-acquiring packet includes routing information indicating a route which the routing information-acquiring packet passed through, the determination processing section may determine that the information processing apparatus is used in the first environment when both the first internal gateway device-identification information and the first external gateway device-identification information are included in the routing information, and may determine that the information processing apparatus is not used in the first environment when at least one of the first internal gateway device-identification information and the first external gateway device-identification information is not included in the routing information.

The information processing apparatus may further include a determination information-management section which manages being-inside-first environment-determining information set in a first transfer packet which is being transferred in the first environment. The determination processing section may determine that the information processing apparatus is used in the first environment when the being-inside-first environment-determining information is set in a reception packet, and may determine that the information processing apparatus is not used in the first environment when the being-inside-first environment-determining information is not set in the reception packet.

The information processing apparatus may further include a determination information-management section which manages first environment-position information indicating a position of the first environment. The determination processing section may acquire current position information indicating a position at which the information processing apparatus is currently present, may determine that the information processing apparatus is used in the first environment when the acquired current position information corresponds to the first environment-position information managed by the determination information-management section, and may determine that the information processing apparatus is not used in the first environment when the acquired current position information does not correspond to the first environment-position information managed by the determination information-management section.

When a connection request is output to such another device from the operating system execution section which executes the operating system included in the first environment group, the communication control section may establish a connection with such another device when the first communication capability information managed by the communication information-management section is set to the communication-capable information, and may output information indicating that the connection with such another device is not possible to the operating system execution section which executes the operating system included in the first environment group when the first communication capability information managed by the communication information-management section is set to the communication-incapable information.

The first environment group information-management section may manage the first environment group which further includes a communication control information-management section that manages VPN server-identification information for identifying a VPN server. When the connection request output from the operating system execution section which executes the operating system included in the first environment group is aimed at the VPN server identified by the VPN server-identification information managed by the communication control information-management section included in the first environment group, the communication control section may establish a connection with the VPN server even when the first communication capability information managed by the communication information-management section is set to the communication-incapable information.

When the operating system execution section which executes the operating system included in the first environment group is connected to such another device, the communication control section may maintain a connection with such another device when the first communication capability information managed by the communication information-management section is set to the communication-capable information, and may disconnect the connection with such another device when the first communication capability information managed by the communication information-management section is set to the communication-incapable information.

The communication control section may output information indicating that the connection with such another device is disconnected to the operating system execution section which executes the operating system included in the first environment group when the first communication capability information managed by the communication information-management section is set to the communication-incapable information.

When the operating system execution section which executes the operating system included in the first environment group is connected to such another device, the first environment group information-management section may manage the first environment group which further includes disconnection processing-type information which is set to information indicating that the connection with such another device is to be maintained or information indicating that the connection with such another device is to be disconnected. When the first communication capability information managed by the communication information-management section is set to the communication-incapable information, the communication control section may maintain the connection with such another device when the disconnection processing-type information included in the first environment group is set to the information indicating that the connection with such another device is to be maintained, and may disconnect the connection with such another device when the disconnection processing-type information included in the first environment group is set to the information indicating that the connection with such another device is to be disconnected.

The first environment group information-management section may manage the first environment group which further includes VPN server-identification information for identifying a VPN server. When a connection destination of the operating system execution section which executes the operating system included in the first environment group is the VPN server identified by the VPN server-identification information included in the first environment group, the communication control section may maintain a connection with the VPN server even when the first communication capability information managed by the communication information-management section is set to the communication-incapable information.

The information processing apparatus may further include an outside-environment group information-management section which manages an outside-environment group including an operating system executed outside the first environment. The communication information-management section may further manage outside-environment communication capability information which is set to communication-capable information indicating that the communication with such another device is possible or communication-incapable information indicating that the communication with such another device is not possible. The determination processing section may set the outside-environment communication capability information to the communication-incapable information when the determination processing section sets the first communication capability information managed by the communication information-management section to the communication-capable information, and may set the outside-environment communication capability information to the communication-capable information when the determination processing section sets the first communication capability information managed by the communication information-management section to the communication-incapable information. The communication control section may control communication with such another device performed by an operating system execution section which executes the operating system included in the outside-environment group, based on the outside-environment communication capability information managed by the communication information-management section.

The information processing apparatus may further include a second environment group information-management section which manages a second environment group including an operating system executed in a second environment, and an outside-environment group information-management section which manages an outside-environment group including an operating system executed outside the first environment. The communication information-management section may further manage second communication capability information which is set to communication-capable information indicating that the communication with such another device is possible or communication-incapable information indicating that the communication with such another device is not possible, and may also manage outside-environment communication capability information which is set to communication-capable information indicating that the communication with such another device is possible or communication-incapable information indicating that the communication with such another device is not possible. The determination processing section may determine at the predetermined timing whether or not the information processing apparatus is used in the second environment, may set the second communication capability information managed by the communication information-management section to the communication-capable information when the determination processing section determines that the information processing apparatus is used in the second environment, may set the second communication capability information managed by the communication information-management section to the communication-incapable information when the determination processing section determines that the information processing apparatus is not used in the second environment, may set the outside-environment communication capability information to the communication-incapable information when the determination processing section sets at least one of the first communication capability information and the second communication capability information which are managed by the communication information-management section to the communication-capable information, and may set the outside-environment communication capability information to the communication-capable information when the determination processing section sets both the first communication capability information and the second communication capability information which are managed by the communication information-management section to the communication-incapable information. The communication control section may control communication with such another device performed by an operating system execution section which executes the operating system included in the second environment group, based on the second communication capability information managed by the communication information-management section.

According to the embodiments of the present invention described above, the risk that the information processing apparatus is exposed to can be lowered, which is caused by changing the environment of using the information processing apparatus.

### BRIEF DESCRIPTION OF THE DRAWINGS

FIG. 1 is a diagram showing outlines of functions of an information processing apparatus according to an embodiment of the present invention;

FIG. 2 is a diagram showing a functional configuration of the information processing apparatus according to the embodiment;

FIG. 3 is a diagram showing an example of information managed by a being-inside-office determination information-management section of the information processing apparatus according to the embodiment;

FIG. 4 is a diagram showing an example of information managed by a communication control information-management section of the information processing apparatus according to the embodiment;

FIG. 5 is a diagram showing an example of information managed by a communication information-management section of the information processing apparatus according to the embodiment;

FIG. 6 is a diagram showing an example of a guest OS group-selection screen displayed by a display control section of the information processing apparatus according to the embodiment;

FIG. 7 is a flowchart showing a flow of being-inside-office determination processing executed by a being-inside-office determination processing section of the information processing apparatus according to the embodiment;

FIG. 8 is a flowchart showing a flow of processing of an existing connection executed by a communication control section of the information processing apparatus according to the embodiment; and

FIG. 9 is a flowchart showing a flow of processing of a new connection executed by the communication control section of the information processing apparatus according to the embodiment.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted. In the case of distinguishing structural elements of one embodiment from structural elements of another embodiment, the structural elements are denoted with different reference numerals (for example, XA, XB, . . . ), and in the case of not distinguishing structural elements of one embodiment from structural elements of another embodiment, the structural elements are denoted with the same reference numerals (for example, X).

Note that the description will be given in the following order.

1. Embodiment
1-1. Outlines of functions of information processing apparatus
1-2. Functional configuration of information processing apparatus
1-3. Example of information managed by being-inside-office determination information-management section
1-4. Example of information managed by communication control information-management section
1-5. Example of information managed by communication information-management section
1-6. Example of guest OS group-selection screen displayed by display control section
1-7. Flow of being-inside-office determination processing executed by being-inside-office determination processing section
1-8. Flow of processing of existing connection executed by communication control section
1-9. Flow of processing of new connection executed by communication control section

2. Modified example

3. Summary

### 1. Embodiment

First, an embodiment of the present invention will be described. As described above, there is a possibility that a PC is exposed to various risks depending on the change in the environment in which the PC is used. According to the present embodiment, the risks can be lowered. The PC is an example of an information processing apparatus.

[1-1. Outlines of Functions of Information Processing Apparatus]

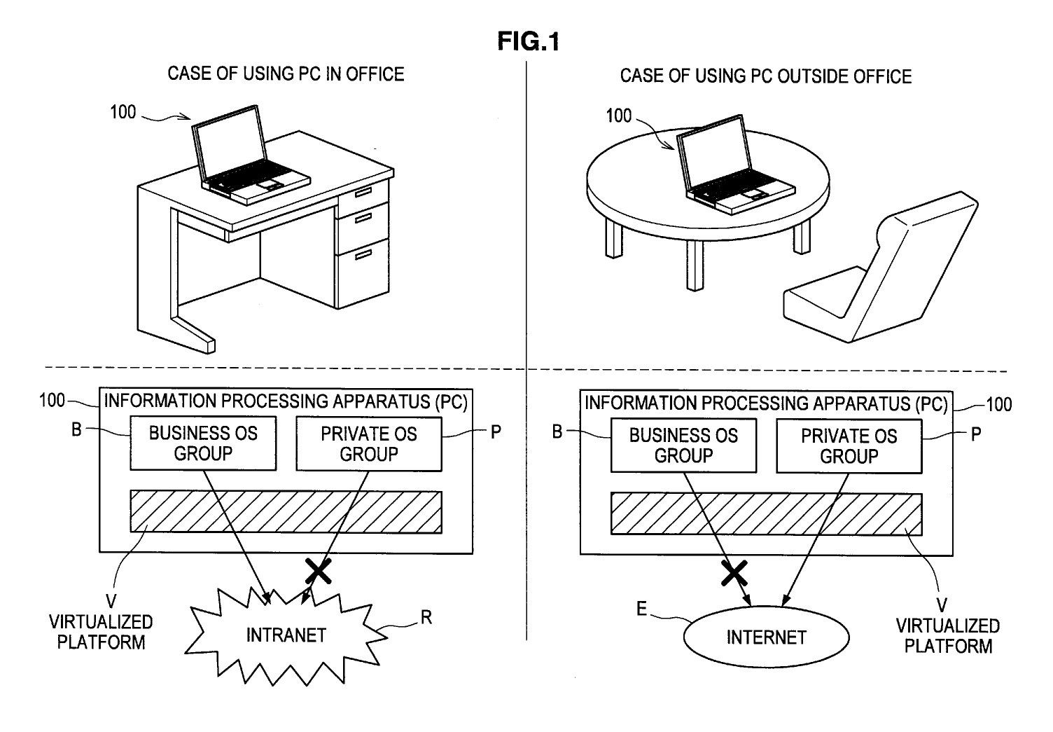

FIG. 1 is a diagram showing outlines of functions of an information processing apparatus according to an embodiment of the present invention. With reference to FIG. 1, the outlines of functions of the information processing apparatus according to the embodiment will be described.

As shown in FIG. 1, in the present embodiment, description will be made by assuming a case where a PC 100 is used by a user in the office and a case where the PC 100 is used by the user outside the office such as inside the home. For example, in the case where the user brings the PC 100 used in the office to outside the office such as inside the home, important data may be stored in the PC 100 in the office, and the PC 100 may be connected to a network such as Internet E outside the office. In such a case, the important data stored in the PC 100 is exposed to the risk of being leaked via the Internet E.

Further, for example, in the case of bringing the PC 100, which is brought and used outside the office such as inside the home, into the office and using the PC 100 inside the office, the PC 100 may be infected with a virus outside the office via a network such as the Internet E, and the PC 100 may be connected to an in-company intranet R or the like after arriving for work. In such a case, there may be a risk of the virus with which the PC 100 is infected being spread via the intranet R in the office.

In the present embodiment, whether an operating system (hereinafter, also referred to as “OS”) installed in the PC 100 is to be used in the office or outside the office can be set by the user. The user sets an OS to be used in the office in a manner that the OS belongs to a business OS group B, and the user sets an OS to be used outside the office in a manner that the OS belongs to a private OS group P. The OS is an example of a program, and manages the whole PC 100.

Then, in the case where the PC 100 is used in the office, the PC 100 controls an OS which is set to belong to the business OS group B so as to be capable of communicating with another device via the in-company intranet R or the like, and the PC 100 controls an OS which is set to belong to the private OS group P so as to be incapable of communicating with another device via the in-company intranet R or the like. On the other hand, in the case where the PC 100 is used outside the office, the PC 100 controls an OS which is set to belong to the business OS group B so as to be incapable of communicating with another device via the Internet E or the like, and the PC 100 controls an OS which is set to belong to the private OS group P so as to be capable of communicating with another device via the Internet E or the like.

By performing such controls, the risk can be lowered, for example, that important data stored in the PC 100 while using the PC 100 in the office may be leaked via the Internet E outside the office. Further, the risk can be lowered, for example, that the virus with which the PC 100 is infected when using the PC 100 outside the office may be spread via the intranet R in the office. Such controls can be executed by a virtualized platform V, which controls both the business OS group B communication and the private OS group P communication, for example. By using the virtualization technology mentioned above, the PC 100 can control the business OS group B communication and the private OS group P communication without making the user conscious of the settings described above.

In the present embodiment, the user sets an OS to be used in the office in a manner that the OS belongs to the business OS group B, and sets an OS to be used outside the office in a manner that the OS belongs to the private OS group P. However, the way of sorting the OS's into groups is not limited to the above pattern. For example, the user sets an OS to be used inside the school in a manner that the OS belongs to a school OS group, and sets an OS to be used outside the school in a manner that the OS belongs to an outside-school OS group. That is, the user can set an OS to be used inside an environment in a manner that the OS belongs to an environment OS group, and can set an OS to be used in an environment other than the above environment in a manner that the OS belongs to an outside-environment OS group.

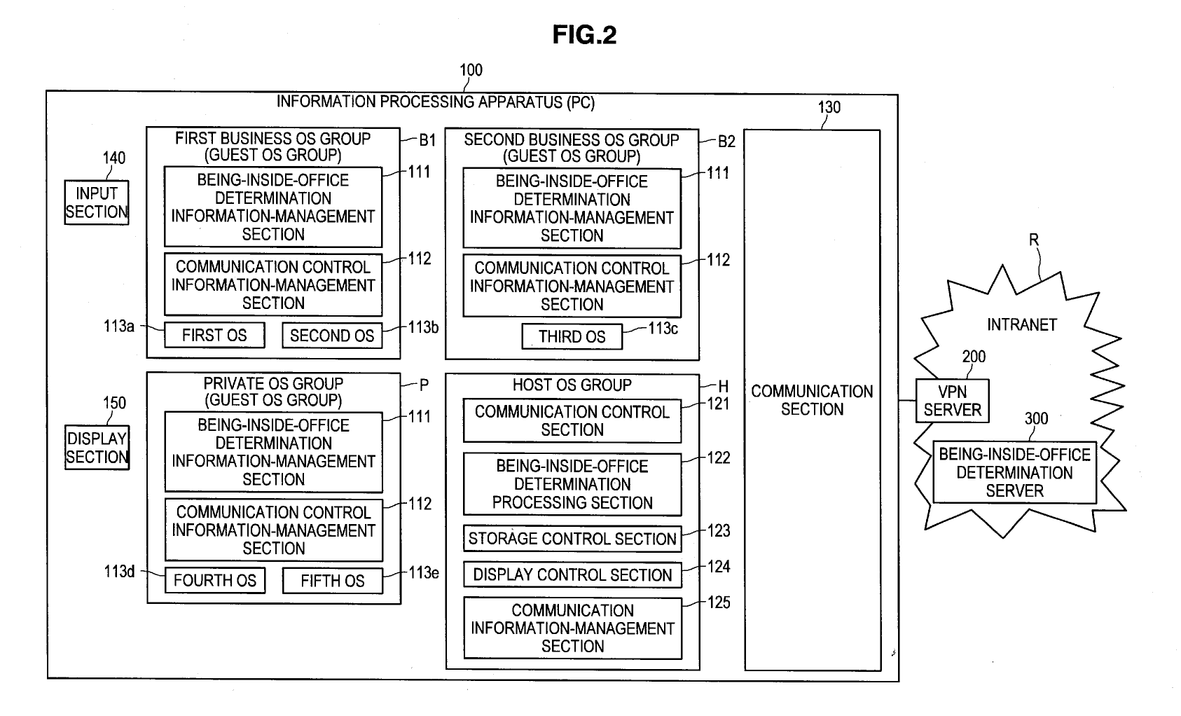

Further, the number of business OS groups B present inside the PC 100 is at least one, and may be multiple. In the description from FIG. 2 onward, the number of business OS groups B present inside the PC 100 is two (a first business OS group B1 and a second business OS group B2). Further, the private OS group P is not necessarily present inside the PC 100. Further, the business OS group B and the private OS group P are collectively referred to as guest OS groups, and a group to which the OS providing the virtualized platform V belongs is referred to as host OS group.

[1-2. Functional Configuration of Information Processing Apparatus]

FIG. 2 is a diagram showing a functional configuration of the information processing apparatus according to the embodiment of the present invention. With reference to FIG. 2, the functional configuration of the information processing apparatus according to the embodiment will be described.

As shown in FIG. 2, the PC 100 serving as an example of the information processing apparatus according to the present embodiment mainly includes a first business OS group B1, a second business OS group B2, a private OS group P, a host OS group H, a communication section 130, an input section 140, and a display section 150. The communication section 130 has a function of communicating with another device. The input section 140 has a function of accepting input of operation information from the user. The display section 150 has a function of displaying various types of information by control performed by a display control section 124, which will be described later.

The first business OS group B1 includes a first OS 113a and a second OS 113b, which are executed inside an office A. The first business OS group B1 is managed by a first business OS group information-management section, which the PC 100 is provided with, for example. Here, the first business OS group B1 includes the first OS 113a and the second OS 113b, but the number of OS's included in the first business OS group B1 is not particularly limited as long as it is one or more.

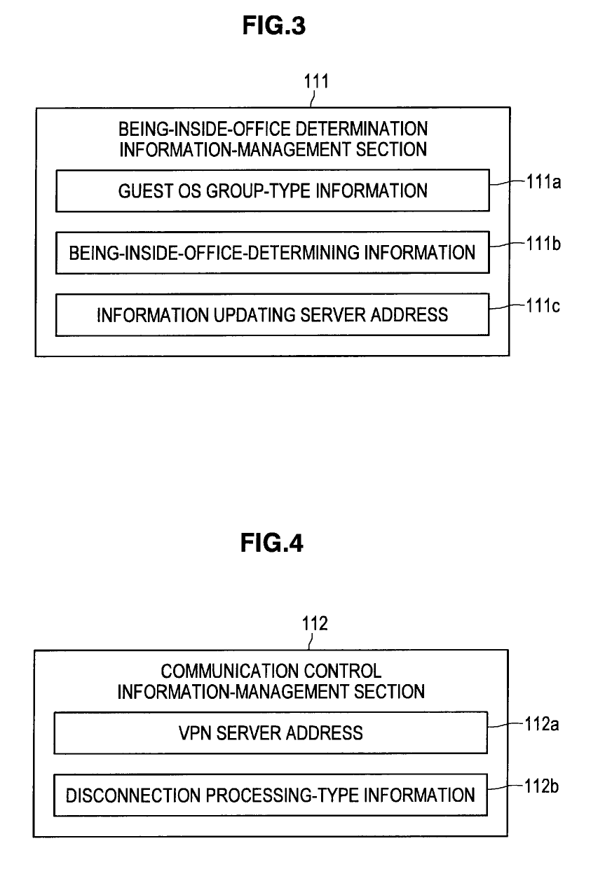

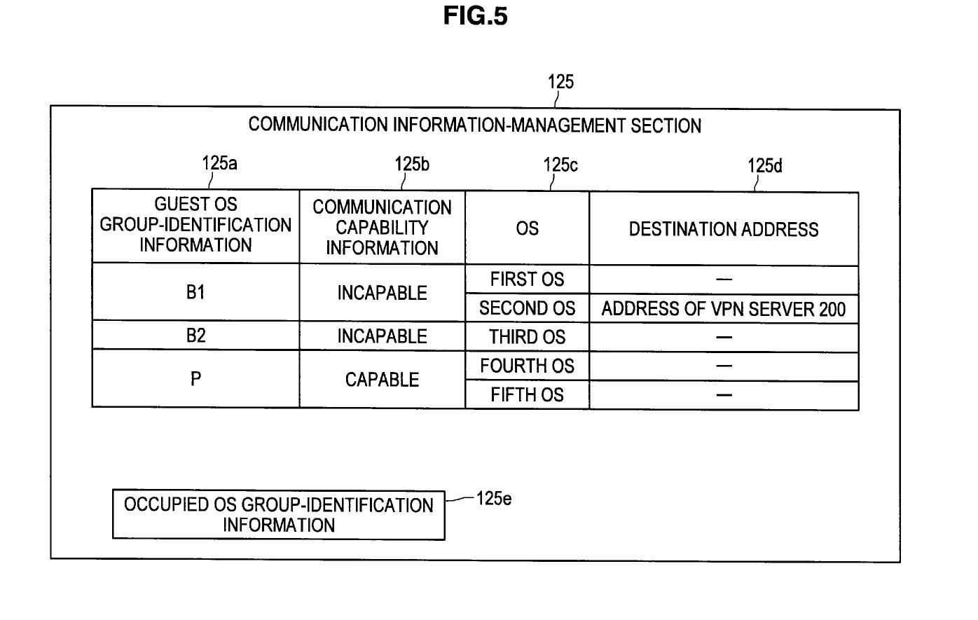

The host OS group H mainly includes a communication control section 121, a being-inside-office determination processing section 122, a storage control section 123, the display control section 124, a communication information-management section 125, and the like. The respective functional blocks are controlled by executing a host OS. Information managed by the communication information-management section 125 will be described later with reference to FIG. 5. The first business OS group B1 mainly includes a being-inside-office determination information-management section 111, a communication control information-management section 112, the first OS 113a, the second OS 113b, and the like. The second business OS group B2 mainly includes a being-inside-office determination information-management section 111, a communication control information-management section 112, a third OS 113c, and the like. Information managed by the being-inside-office determination information-management section 111 will be described later with reference to FIG. 3. Information managed by the communication control information-management section 112 will be described later with reference to FIG. 4. The private OS group P mainly includes a being-inside-office determination information-management section 111, a communication control information-management section 112, a fourth OS 113d, a fifth OS 113e, and the like.

The communication control section 121, the being-inside-office determination processing section 122, the storage control section 123, the display control section 124, and the like are configured from, for example, a CPU (Central Processing Unit) and a RAM (Random Access Memory), and the functions thereof are realized by developing a host OS stored in a storage section (not shown) in the RAM by the CPU and executing the developed host OS by the CPU. The communication information-management section 125, the being-inside-office determination information-management sections 111 of the respective groups, the communication control information-management sections 112 of the respective groups, and the like are configured from, for example, a HDD (Hard Disk Drive) and a non-volatile memory.

The communication information-management section 125 has a function of managing communication capability information which is set to communication-capable information indicating that communication with another device is possible, or communication-incapable information indicating that the communication with another device is not possible. The communication capability information is managed by the communication information-management section 125 per guest OS group. Hereinafter, as a matter of convenience, the communication-capable information may be simply referred to as “capable”, and the communication-incapable information may be simply referred to as “incapable”.

The being-inside-office determination processing section 122 has a function of determining at a predetermined timing whether or not the PC 100 is used in an environment in which the OS's (the first OS 113a and the second OS 113b) belonging to the first business OS group B1 should be used. Here, for example, let us assume that the environment in which the OS's belonging to the first business OS group B1 should be used is inside an office A. In the case where it is determined that the PC 100 is used inside the office A, the being-inside-office determination processing section 122 sets the communication capability information managed by the communication information-management section 125 to “capable”, and in the case where it is determined that the PC 100 is not used inside the office A, the being-inside-office determination processing section 122 sets the communication capability information managed by the communication information-management section 125 to “incapable”. As shown in FIG. 2, in the case where there are multiple business OS groups B, the communication capability information may be managed by communication information-management section 125 in association with guest OS group-identification information. In this case, the being-inside-office determination processing section 122 may set the communication capability information, which is managed by the communication information-management section 125 in association with the guest OS group-identification information that corresponds to information for identifying the office A, to “capable” or “incapable”. Note that the being-inside-office determination processing section 122 functions as an example of a determination processing section.

The predetermined timing may be any timing, and for example, may be set on predetermined time period basis. Further, the predetermined timing may be a timing at which a connection with a network is detected by the communication control section 121. There can be assumed various techniques as the technique for the being-inside-office determination processing section 122 to determine whether or not the PC 100 is used in the office A.

For example, let us assume that a being-inside-office determination server 300, which is for determining whether or not the PC 100 is used in the office A, is prepared in the intranet R of the office A. The being-inside-office determination server 300 has a function of establishing, in the case of receiving a connection request from a device used in the office A, a connection with the device. The first business OS group B1 of the PC 100 is provided with the being-inside-office determination information-management section 111 which manages determination server-identification information for identifying the being-inside-office determination server 300, for example. As the determination server-identification information, there can be used an address of the being-inside-office determination server 300 and the like. The being-inside-office determination information-management section 111 functions as an example of a determination information-management section. The determination server-identification information is managed by, for example, the being-inside-office determination information-management section 111 as an example of being-inside-office-determining information.

The being-inside-office determination processing section 122 transmits a connection request to the being-inside-office determination server 300 identified by the determination server-identification information managed by the being-inside-office determination information-management section 111, for example. In the case where the connection with the being-inside-office determination server 300 is established, the being-inside-office determination processing section 122 may determine that the PC 100 is used in the office A, and in the case where the connection with the being-inside-office determination server 300 is not established, the being-inside-office determination processing section 122 may determine that the PC 100 is not used in the office A. In those cases, in order to confirm that the being-inside-office determination server 300 is not a fake server, the being-inside-office determination processing section 122 may perform authentication processing for confirming that the being-inside-office determination server 300 is the genuine server. In this case, authentication information which is necessary for the authentication processing may also be managed by the being-inside-office determination information-management section 111 as an example of the being-inside-office-determining information.

Further, for example, when an external device is provided in a predetermined environment other than the office A, the PC 100 may transmit a routing information-acquiring packet to the external device, and based on routing information included in a response packet with respect to the routing information-acquiring packet, whether or not the PC 100 is used in the office A may be determined. In that case, there is provided, in the first business OS group B1 of the PC 100, the being-inside-office determination information-management section 111 which manages internal gateway device-identification information for identifying an internal gateway device that is present in the office A and external gateway device-identification information for identifying an external gateway device that is present in a predetermined environment other than the office A, for example. The being-inside-office determination processing section 122 transmits the routing information-acquiring packet to the external device that is present in the predetermined environment other than the office A.

When the response packet with respect to the routing information-acquiring packet includes routing information indicating a route which the routing information-acquiring packet passed through, in the case where both the internal gateway device-identification information and the external gateway device-identification information are included in the routing information, the being-inside-office determination processing section 122 determines that the PC 100 is used in the office A. Further, in the case where at least one of the internal gateway device-identification information and the external gateway device-identification information is not included in the routing information, the being-inside-office determination processing section 122 determines that the PC 100 is not used in the office A. Such a technique is known as a technology using so-called traceroute. The internal gateway device-identification information and the external gateway device-identification information are each managed by the being-inside-office determination information-management section 111 as an example of being-inside-office-determining information, for example. Also, external device-identification information for identifying the external device provided in the predetermined environment other than the office A is managed by the being-inside-office determination information-management section 111 as an example of being-inside-office-determining information, and may be used at the time of transmitting the routing information-acquiring packet.

Further, for example, in the case where the PC 100 could receive a transfer packet which is being transferred in the office A, the PC 100 may determine that the PC 100 is used in the office A. In that case, there is provided, in the first business OS group B1 of the PC 100, the being-inside-office determination information-management section 111 which manages being-inside-office A-determining information set in the transfer packet as the being-inside-office-determining information. In the case of receiving the packet, the being-inside-office determination processing section 122 determines whether or not the being-inside-office A-determining information is set in the received packet. In the case where the being-inside-office A-determining information is set in the received packet, the being-inside-office determination processing section 122 determines that the PC 100 is used in the office A. Further, in the case where the being-inside-office A-determining information is not set in the received packet, the being-inside-office determination processing section 122 determines that the PC 100 is not used in the office A.

A fake transfer packet may be generated, and by causing the PC 100 to receive the fake transfer packet, it is possible to make the PC 100 looks as if it is used in the office A. Consequently, the being-inside-office determination processing section 122 may perform authentication processing for confirming that the transfer packet is the genuine packet. In that case, authentication information which is necessary for the authentication processing may be managed by the being-inside-office determination information-management section 111 as an example of the being-inside-office-determining information. The transfer packet may be generated by extending a protocol such as an LLTD (Link-Layer Topology Discovery), an ARP (Address Resolution Protocol), and a DHCP (Dynamic Host Configuration Protocol), or may be individually generated.

Further, for example, in the case where the PC 100 has a function of acquiring position information indicating a position at which the PC 100 is present, it may be determined whether or not the PC 100 is used in the office A based on the acquired position information. In that case, there is provided, in the PC 100, the being-inside-office determination information-management section 111 which manages office A-position information indicating a position of the office A as the being-inside-office-determining information. The being-inside-office determination processing section 122 acquires current position information indicating a position at which the PC 100 is currently present, and determines whether or not the acquired current position information corresponds to the office A-position information managed by the being-inside-office determination information-management section 111.

In the case where it is determined that the current position information corresponds to the office A-position information, the being-inside-office determination processing section 122 determines that the PC 100 is used in the office A. Further, in the case where it is determined that the current position information does not correspond to the office A-position information, the being-inside-office determination processing section 122 determines that the PC 100 is not used in the office A. The technique for the PC 100 to acquire the current position information is not particularly limited, and the PC 100 may acquire the current position information using a GPS (Global Positioning System), for example.

The being-inside-office determination information-management section 111 manages various types of being-inside-office-determining information used for the being-inside-office determination, and it is assumed that the various types of being-inside-office-determining information are rendered not to be easily changed by the user. Therefore, for example, the being-inside-office determination processing section 122 may update the being-inside-office-determining information by using information acquired from an information updating server. In doing so, the being-inside-office determination processing section 122 may perform authentication processing for confirming that the information updating server is the genuine server. For example, the being-inside-office determination processing section 122 may acquire the being-inside-office-determining information by automatically polling the information updating server. The polling may be performed every predetermined time period. The information updating server may be the same as or different from the being-inside-office determination server 300. For example, information updating server-identification information for identifying the information updating server may be managed by the being-inside-office determination information-management section 111, and may be used for identifying the information updating server by the being-inside-office determination processing section 122.

In the same manner, the being-inside-office determination processing section 122 has a function of determining at a predetermined timing whether or not the PC 100 is used in an environment in which the OS (third OS 113c) belonging to the second business OS group B2 should be used. In the same technique as the technique used in the case of the first business OS group B1, the being-inside-office determination processing section 122 sets the communication capability information, which is managed by the communication information-management section 125 in association with guest OS group-identification information which corresponds to information for identifying an office B, to “capable” or “incapable”. The predetermined timing used in the first business OS group B1 and the predetermined timing used in the second business OS group B2 may be the same as or different from each other.

In the case of the private OS group P, the being-inside-office determination processing section 122 may not determine whether or not the PC 100 is used in an environment in which an OS belonging to the group should be used. Whether each guest OS group is the business OS group B or the private OS group P can be set in guest OS group-type information 111a which is managed by the being-inside-office determination information-management section 111. By referring to the guest OS group-type information 111a, the being-inside-office determination processing section 122 can determine whether each guest OS group provided to the PC 100 is the business OS group B or the private OS group P.

The communication control section 121 has a function of controlling communication with another device performed by an OS execution section which executes an OS included in the first business OS group B1, based on the communication capability information managed by the communication information-management section 125. For example, in the case where the communication capability information of the first business OS group B1 is set to “capable”, the communication control section 121 permits the communication with the other device performed by the OS execution section, and in the case where the communication capability information of the first business OS group B1 is set to “incapable”, the communication control section 121 limits the communication with the other device performed by the OS execution section.

For example, let us assume a case where a connection request is output to the other device from the OS execution section which executes the OS included in the first business OS group B1. In that case, when the communication capability information managed by the communication information-management section 125 is set to “capable”, the communication control section 121 establishes a connection with the other device. When establishing a connection with the other device, the communication control section 121 registers an address of the destination device for a destination address of the OS of the connection request source which is managed by the communication information-management section 125. Further, when the communication capability information managed by the communication information-management section 125 is set to “incapable”, the communication control section 121 outputs information indicating that the connection with the other device is not possible to the OS execution section which executes the OS included in the first business OS group B1. By such a technique, the communication control section 121 can control the communication with the other device in the case of a new connection is requested from the OS execution section which executes the OS included in the first business OS group B1.

Further, when the information indicating that the connection with the other device is not possible is explicitly output to the OS execution section of the connection request source, it can be immediately grasped that the OS execution section of the connection request source is incapable of being connected to the other device. As the information indicating that the connection with the other device is not possible, there can be used an ICMP (Internet Control Message Protocol) packet, for example.

However, the communication control section 121 may perform control in a manner that communication is permitted to a VPN (Virtual Private Network) server 200 in the intranet R. That is, a group information-management section of the first business OS group B1 manages the first business OS group B1 which further includes the communication control information-management section 112 that manages VPN server-identification information for identifying the VPN server 200. Then, in the case where the connection request output from the OS execution section which executes the OS included in the first business OS group B1 is aimed at the VPN server 200 identified by the VPN server-identification information managed by the communication control information-management section 112 included in the first business OS group B1, the communication control section 121 establishes a connection with the VPN server 200 even in the case where the communication capability information managed by the communication information-management section 125 is set to “incapable”.

Further, for example, let us assume a case where the OS execution section which executes the OS included in the first business OS group B1 is connected to another device. The communication control section 121 can easily grasp which OS is connected to which device. For example, in the communication information-management section 125, a destination address is managed per OS, and in the case where an OS is connected to another device, an address of the other device serving as the connection partner is registered for a destination address of the OS. The communication control section 121 can grasp which OS is connected to which device by referring to the destination address.

In the case where the communication capability information managed by the communication information-management section 125 is set to “capable”, the communication control section 121 maintains a connection with another device, and in the case where the communication capability information managed by the communication information-management section 125 is set to “incapable”, the communication control section 121 disconnects the connection with the other device. In the case of disconnecting the connection with the other device, the communication control section 121 deletes the address of the destination device from destination addresses of OS's of connection sources managed by the communication information-management section 125. The communication control section 121 can control communication with another device by such a technique in the case where an existing connection is requested from the OS execution section which executes the OS included in the first business OS group B1.

In the case where the communication capability information managed by the communication information-management section 125 is set to “incapable”, the communication control section 121 may output information indicating that the connection with the other device is disconnected to the OS execution section which executes the OS included in the first business OS group B1. In this way, when the information indicating that the connection with the other device is disconnected is explicitly output to the OS execution section of the connection source, it can be immediately grasped that the OS execution section of the connection source becomes incapable of communicating with the other device. As the information indicating that the connection with the other device is disconnected, there can be used an RST (ReSeT) of a TCP (Transmission Control Protocol), for example.

Let us assume a case where the OS execution section which executes the OS included in the first business OS group B1 is connected to the other device. In this case, the first business OS group information-management section may manage the first business OS group B1 group which further includes disconnection processing-type information. In the case where the communication capability information managed by the communication information-management section 125 is set to “incapable”, the disconnection processing-type information is set to information indicating that the connection with the other device is to be maintained or information indicating that the connection with the other device is to be disconnected.

In the case where the communication capability information managed by the communication information-management section 125 is set to “incapable”, and in the case where the disconnection processing-type information included in the first business OS group B1 is set to the information indicating that the connection with the other device is to be maintained, the communication control section 121 maintains the connection with the other device. Further, in the case where the communication capability information managed by the communication information-management section 125 is set to “incapable”, and in the case where the disconnection processing-type information included in the first business OS group B1 is set to the information indicating that the connection with the other device is to be disconnected, the communication control section 121 disconnects the connection with the other device.

However, the communication control section 121 may perform control in a manner that communication is permitted to the VPN server 200 in the intranet R. That is, a group information-management section of the first business OS group B1 manages the first business OS group B1 which further includes the communication control information-management section 112 that manages VPN server-identification information for identifying the VPN server 200. Then, in the case where the connection destination of the OS execution section which executes the OS included in the first business OS group B1 is aimed at the VPN server 200 identified by the VPN server-identification information managed by the communication control information-management section 112 included in the first business OS group B1, the communication control section 121 maintains a connection with the VPN server 200 even in the case where the communication capability information managed by the communication information-management section 125 is set to “incapable”.

The communication control section 121 can control the communication with another device performed by the OS execution section which executes an OS included in the second business OS group B2 by the same technique as the technique performed to the first business OS group B1.

Further, the PC 100 may perform control in a manner that, regarding an OS execution section which executes an OS included in the private OS group P, the PC 100 is communicable to the OS execution section for the first time when the PC 100 comes into a state where the PC 100 is not present in any office. In the case where the communication capability information of every business OS group B managed by the communication information-management section 125 is set to “capable”, the being-inside-office determination processing section 122 sets the communication capability information of the private OS group P to “incapable”. Further, in the case where the communication capability information of every business OS group B managed by the communication information-management section 125 is set to “incapable”, the being-inside-office determination processing section 122 sets the communication capability information of the private OS group P to “capable”. The communication control section 121 may control the communication with another device performed by the OS execution section which executes the OS included in the private OS group P based on the communication capability information of the private OS group P.

The storage control section 123 has functions of acquiring guest OS group-type information and information updating server-identification information from operation information the input of which is accepted by the input section 140, and registering the guest OS group-type information and the information updating server-identification information in the being-inside-office determination information-management section 111. Further, the storage control section 123 has functions of acquiring VPN server-identification information and disconnection processing-type information from the operation information the input of which is accepted by the input section 140, and registering the VPN server-identification information and the disconnection processing-type information in the communication control information-management section 112. Still further, the storage control section 123 has functions of acquiring identification information for identifying an OS group that a user wants to use from the operation information the input of which is accepted by the input section 140, and registering the identification information as occupied OS group-identification information in the communication information-management section 125. An OS belonging to the group identified by the occupied OS group-identification information registered here is executed.

The display control section 124 has a function of displaying, on the display section 150, based on the operation information the input of which is accepted by the input section 140, the guest OS group-identification information, the communication capability information, the information for identifying an OS, and the like, which are managed by the communication information-management section 125.

[1-3. Example of Information Managed by being-Inside-Office Determination Information-Management Section]

FIG. 3 is a diagram showing an example of information managed by a being-inside-office determination information-management section of the information processing apparatus according to the embodiment of the present invention. With reference to FIG. 3, the example of information managed by the being-inside-office determination information-management section of the information processing apparatus according to the embodiment will be described.

The being-inside-office determination information-management section 111, which each guest OS group is provided with, manages various types of information of the group. As shown in FIG. 3, the various types of information of the group include guest OS group-type information 111a, being-inside-office-determining information 111b, an information updating server address 111c, and the like. However, the being-inside-office determination information-management section 111 of the private OS group P may not manage the being-inside-office-determining information 111b and the information updating server address 111c. The guest OS group-type information 111a is information for identifying a type of each guest OS group which the PC 100 is provided with, and is set to information for identifying a type of the business OS group B or information for identifying a type of the private OS group P.

The being-inside-office-determining information 111b represents various types of information used for determining, by the being-inside-office determination processing section 122, whether or not the PC 100 is used in an environment in which the an OS belonging to the group should be used. The information updating server address 111c is an example of information updating server-identification information for identifying an information updating server, and the being-inside-office-determining information 111b is updated by the information acquired from the information updating server specified by the information updating server address 111c.

[1-4. Example of Information Managed by Communication Control Information-Management Section]

FIG. 4 is a diagram showing an example of information managed by a communication control information-management section of the information processing apparatus according to the embodiment of the present invention. With reference to FIG. 4, the example of information managed by the communication control information-management section of the information processing apparatus according to the embodiment will be described.

The communication control information-management section 112, which each guest OS group is provided with, manages various types of information of the group. As shown in FIG. 4, the various types of information of the group include a VPN server address 112a, disconnection processing-type information 112b, and the like. However, the communication control information-management section 112 of the private OS group P may not manage the VPN server address 112a. The VPN server address 112a is an address for specifying the VPN server 200 corresponding to the group, and is an example of the VPN server-identification information.

In the case where the communication capability information of the group managed by the communication information-management section 125 is set to “incapable”, the disconnection processing-type information 112b is set to information indicating that the connection with the other device is to be maintained or information indicating that the connection with the other device is to be disconnected. By referring to the setting, the communication control section 121 can perform control of causing the OS execution section which executes an OS belonging to the group to maintain the connection with the other device, even in the case where the communication capability information of the group is set to “incapable”.

[1-5. Example of Information Managed by Communication Information-Management Section]

FIG. 5 is a diagram showing an example of information managed by a communication information-management section of the information processing apparatus according to the embodiment of the present invention. With reference to FIG. 5, the example of information managed by the communication information-management section of the information processing apparatus according to the embodiment will be described.

The communication information-management section 125 is included in the host OS group H. As shown in FIG. 5, the communication information-management section 125 manages information formed by associating guest OS group-identification information 125a, communication capability information 125b, an OS 125c, a destination address 125d, and the like with each other. The guest OS group-identification information 125a is information for identifying a guest OS group. The communication capability information 125b is for indicating whether the communication with another device is possible or not per group. The OS 125c is information for identifying an OS included in the group. The destination address 125d indicates, in the case where the OS execution section is connected to a device outside the PC 100, an address per OS for specifying the destination device.

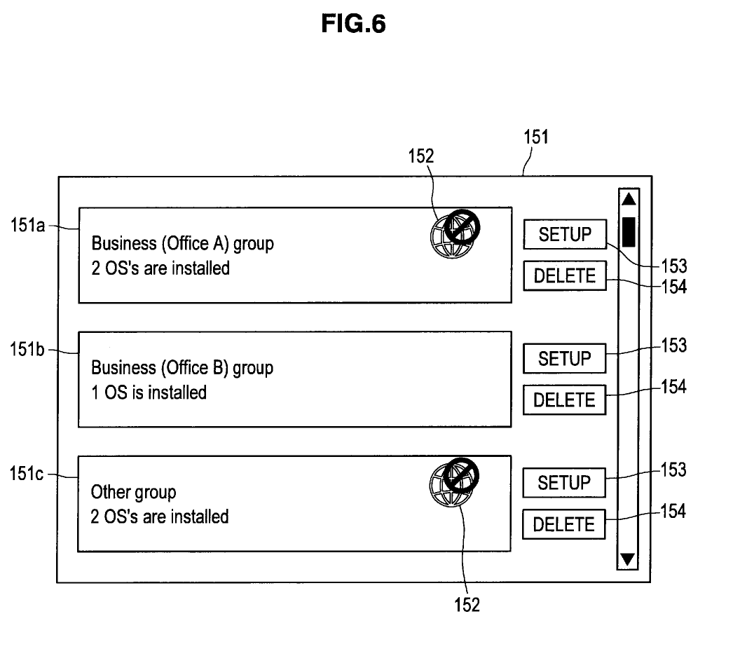

The communication information-management section 125 further manages occupied OS group-identification information 125e. When a group that the user wants to use is selected while viewing a guest OS group-selection screen 151 shown in FIG. 6, group identification information for identifying the selected group is registered in the occupied OS group-identification information 125e. The OS belonging to the group identified by the occupied OS group-identification information registered in the occupied OS group-identification information 125e is executed.

[1-6. Example of Guest Os Group-Selection Screen Displayed by Display Control Section]

FIG. 6 is a diagram showing an example of a guest OS group-selection screen displayed by a display control section of the information processing apparatus according to the embodiment of the present invention. With reference to FIG. 6, an example of the guest OS group-selection screen displayed by the display control section of the information processing apparatus according to the embodiment will be described.

When the user inputs, to the input section 140, operation information indicating that a guest OS group-selection screen 151 is to be displayed, the display control section 124 displays the guest OS group-selection screen 151 on the display section 150 based on the operation information. The display control section 124 can acquire the guest OS group-identification information 125a, the OS 125c, and the like, which are managed by the communication information-management section 125, and can display the guest OS group identified by the guest OS group-identification information 125a, the number of OS's identified by the OS 125c, and the like.

Further, the display control section 124 acquires the communication capability information 125b managed by the communication information-management section 125, and can display a communication-incapable mark 152 for the group in which the communication capability information is set to “incapable”. Further, the display control section 124 can display a setup button 153 per group, and, for example, when information for selecting the setup button 153 is input by the user via the input section 140, the settings of the group corresponding to the setup button 153 can be changed. Further, the display control section 124 can display a delete button 154 per group, and, for example, when information for selecting the delete button 154 is input by the user via the input section 140, the information of the group corresponding to the delete button 154 can be deleted from the being-inside-office determination information-management section 111, the communication control information-management section 112, the communication information-management section 125, and the like.

[1-7. Flow of being-Inside-Office Determination Processing Executed by Being-Inside-Office Determination Processing Section]

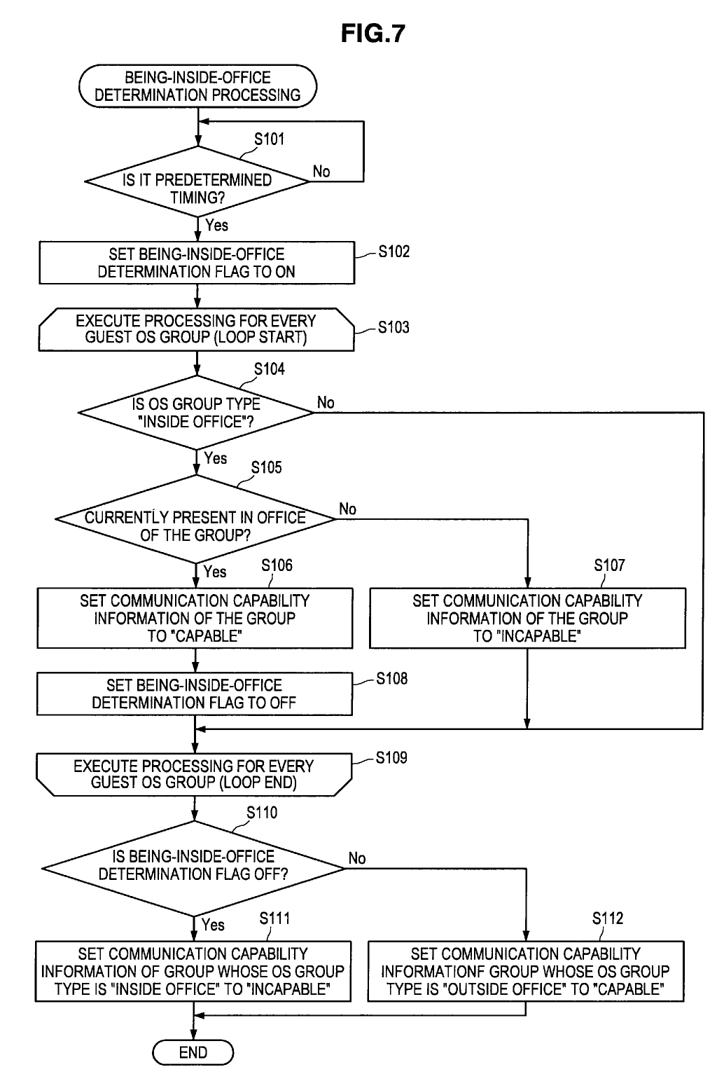

FIG. 7 is a flowchart showing a flow of being-inside-office determination processing executed by a being-inside-office determination processing section of the information processing apparatus according to the embodiment of the present invention. With reference to FIG. 7, the flow of being-inside-office determination processing executed by the being-inside-office determination processing section of the information processing apparatus will be described.

The being-inside-office determination processing section 122 determines whether or not it is a predetermined timing (Step S101), and in the case where it is determined that it is not the predetermined timing (“No” in Step S101), returns to Step S101. In the case where it is determined that it is the predetermined timing (“Yes” in Step S101), the being-inside-office determination processing section 122 sets a being-inside-office determination flag to ON (Step S102), and proceeds to Step S103. The being-inside-office determination flag is set to OFF in the case where the PC 100 is present in any one of the offices, and is set to ON in the case where the PC 100 is not present in any office.

The being-inside-office determination processing section 122 executes repeating processing shown in Step S103 to Step S109 for every guest OS group (Step S103, Step S109). In the repeating processing, the being-inside-office determination processing section 122 determines whether or not the OS group type of the group is “inside office” (Step S104). In the determination, the guest OS group-type information 111a managed by the being-inside-office determination information-management section 111 can be used. In the case where it is determined that the OS group type of the group is “outside office” (not “inside office”) (“No” in Step S104), the being-inside-office determination processing section 122 proceeds to Step S109.

In the case where it is determined that the OS group type of the group is “inside office” (“Yes” in Step S104), the being-inside-office determination processing section 122 determines whether or not the PC 100 is currently present in the office of the group (Step S105). As the determination technique, there can be assumed various techniques as described above. In the case where it is determined that the PC 100 is currently not present in the office of the group (“No” in Step S105), the being-inside-office determination processing section 122 sets the communication capability information 125b of the group to “incapable” (Step S107), and proceeds to Step S109. In the case where it is determined that the PC 100 is currently present in the office of the group (“Yes” in Step S105), the being-inside-office determination processing section 122 sets the communication capability information 125b of the group to “capable” (Step S106), sets the being-inside-office determination flag to OFF (Step S108), and proceeds to Step S109.

When the repeating processing shown in Step S103 to Step S109 is terminated, the being-inside-office determination processing section 122 determines whether or not the being-inside-office determination flag is OFF (Step S110), and in the case where it is determined that the being-inside-office determination flag is OFF (“Yes” in Step S110), sets the communication capability information 125b of the group whose OS group type is “inside office” to “incapable” (Step S111), and terminates the being-inside-office determination processing. In the case where it is determined that the being-inside-office determination flag is ON (“No” in Step S110), the being-inside-office determination processing section 122 sets the communication capability information 125b of the group whose OS group type is “outside office” to “capable” (Step S112), and terminates the being-inside-office determination processing.

[1-8. Flow of Processing of Existing Connection Executed by Communication Control Section]

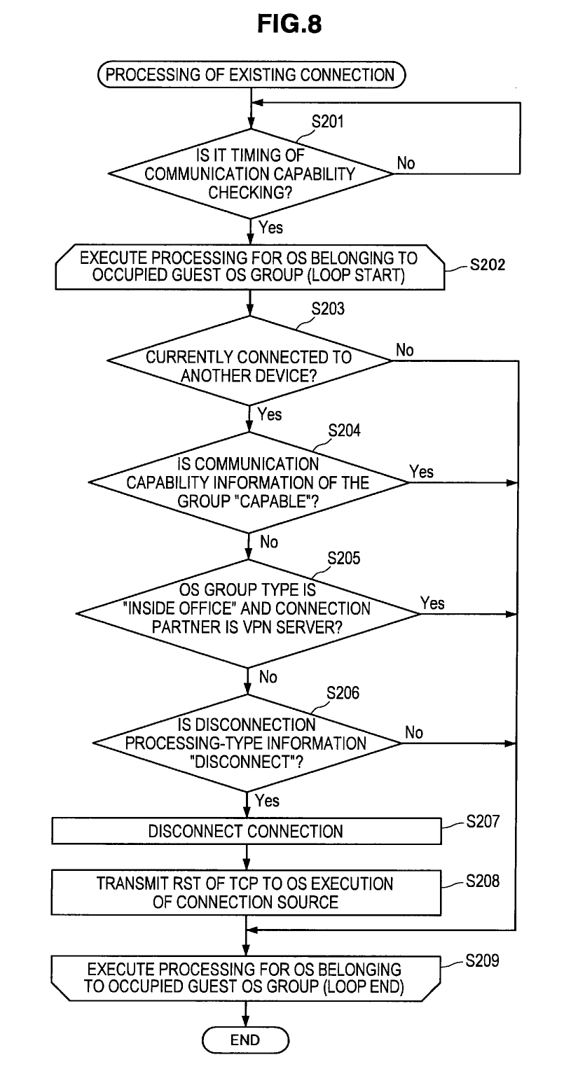

FIG. 8 is a flowchart showing a flow of processing of an existing connection executed by a communication control section of the information processing apparatus according to the embodiment of the present invention. With reference to FIG. 8, the flow of processing of an existing connection executed by the communication control section of the information processing apparatus according to the embodiment will be described.

The communication control section 121 determines whether or not it is a timing of communication capability checking (Step S201). In the case where it is determined that it is not the timing of communication capability checking (“No” in Step S201), the communication control section 121 returns to Step S201. In the case where it is determined that it is the timing of communication capability checking (“Yes” in Step S201), the communication control section 121 proceeds to Step S202.

The communication control section 121 executes repeating processing shown in Step S202 to Step S209 for an OS belonging to an occupied guest OS group (Step S202, Step S209). The occupied guest OS group can be grasped by referring to the occupied OS group-identification information 125e managed by the communication information-management section 125. In the repeating processing, the communication control section 121 determines whether or not the OS execution section is currently connected to another device (Step S203). The determination can be grasped by referring to the destination address 125d managed by the communication information-management section 125. In the case where it is determined that the OS execution section is not currently connected to the other device (“No” in Step S203), the communication control section 121 proceeds to Step S209. In the case where it is determined that the OS execution section is currently connected to the other device (“Yes” in Step S203), the communication control section 121 determines whether or not the communication capability information 125b of the group is “capable” (Step S204).

In the case where it is determined that the communication capability information 125b of the group is “capable” (“Yes” in Step S204), the communication control section 121 proceeds to Step S209. In the case where it is determined that the communication capability information 125b of the group is “incapable” (“No” in Step S204), the communication control section 121 determines whether or not the OS group type of the group is “inside office” and the connection partner is a VPN server (Step S205). The connection partner can be grasped by referring to the destination address 125d.

In the case where it is determined that the OS group type of the group is “inside office” and the connection partner is the VPN server (“Yes” in Step S205), the communication control section 121 proceeds to Step S209. In the case where it is determined either that the OS group type of the group is “outside office” or that the connection partner is not the VPN server (“No” in Step S205), the communication control section 121 determines whether the disconnection processing-type information 112b of the group is “disconnect” or not (“maintain”) (Step S206). In the case where it is determined that the disconnection processing-type information 112b of the group is not “disconnect” (“maintain”) (“No” in Step S206), the communication control section 121 proceeds to Step S209. In the case where it is determined that the disconnection processing-type information 112b of the group is “disconnect” (“Yes” in Step S206), the communication control section 121 disconnects the connection (Step S207), deletes the destination address from the destination address 125d, transmits an RST of a TCP to the OS execution section of the connection source (Step S208), and proceeds to Step S209.

When the repeating processing shown in Step S202 to Step S209 is terminated, the communication control section 121 terminates the processing of the existing connection.

[1-9. Flow of Processing of New Connection Executed by Communication Control Section]

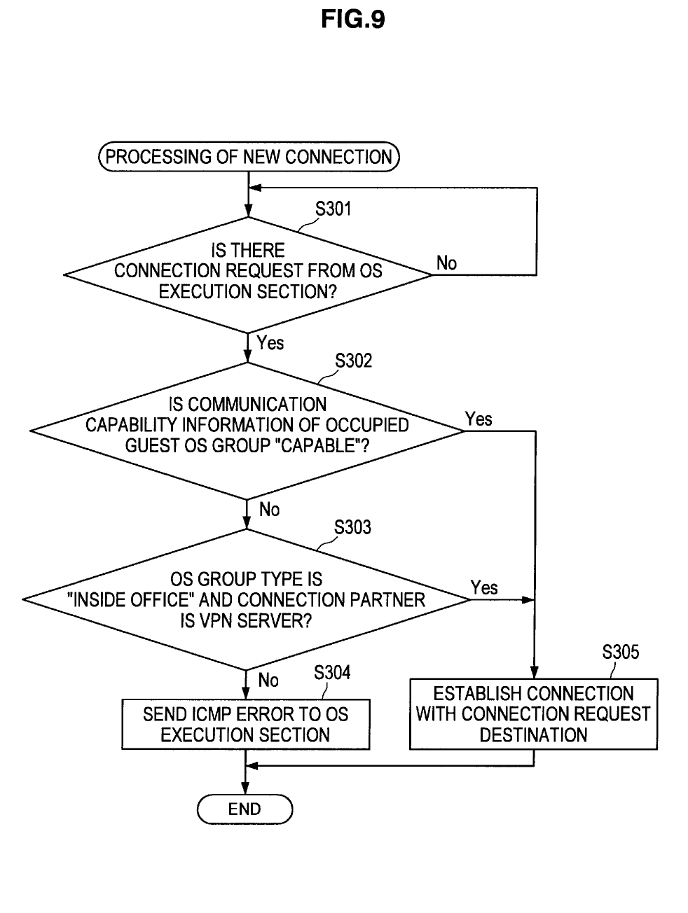

FIG. 9 is a flowchart showing a flow of processing of a new connection executed by the communication control section of the information processing apparatus according to the embodiment of the present invention. With reference to FIG. 9, the flow of processing of a new connection executed by the communication control section of the information processing apparatus according to the embodiment will be described.

The communication control section 121 determines whether or not there is a connection request from an OS execution section (Step S301). In the case where it is determined that there is no connection request from the OS execution section (“No” in Step S301), the communication control section 121 returns to Step S301. In the case where it is determined that there is a connection request from the OS execution section (“Yes” in Step S301), the communication control section 121 proceeds to Step S302.

The communication control section 121 determines whether or not the communication capability information 125b of an occupied guest OS group is “capable” (Step S302). In the case where it is determined that the communication capability information 125b of the group is “capable” (“Yes” in Step S302), the communication control section 121 establishes a connection with the connection request destination (Step S305), registers the destination address in the destination address 125d, and terminates the processing of the new connection. In the case where it is determined that the communication capability information 125b of the group is “incapable” (“No” in Step S302), the communication control section 121 determines whether or not the OS group type of the group is “inside office” and the connection partner is a VPN server (Step S303).

In the case where it is determined that the OS group type of the group is “inside office” and the connection partner is the VPN server (“Yes” in Step S303), the communication control section 121 establishes a connection with the connection request destination (Step S305), registers the destination address in the destination address 125d, and terminates the processing of the new connection. In the case where it is determined either that the OS group type of the group is “outside office” or that the connection partner is not the VPN server (“No” in Step S303), the communication control section 121 sends an ICMP error to the OS execution section of the connection source (Step S304), and terminates the processing of the new connection.

### 2. Modified Example

It should be understood by those skilled in the art that various modifications, combinations, sub-combinations and alterations may occur depending on design requirements and other factors insofar as they are within the scope of the appended claims or the equivalents thereof.

For example, it is not necessary that the information processing apparatus according to the embodiment of the present invention execute the processing in the order shown in the flowcharts, and the order of the processing may be appropriately changed. Further, the information processing apparatus according to the embodiment of the present invention may execute the processing shown in the flowcharts once, or may execute the processing multiple times repeatedly.

### 3. Summary

According to the present embodiment, the risk that the information processing apparatus is exposed to can be lowered, which is caused by changing the environment of using the information processing apparatus. For example, as for an OS that should be used in the office, in the case where the OS is attempted to be used in the office, the communication with another device is permitted, and in the case where the OS is attempted to be used outside the office, the communication with another device is limited. For example, in the case where important data is stored in a PC in the office using an OS to be used in the office, and when attempting to connect to a network such as the Internet by using the OS when back at home, the risk of the important data stored in the PC being leaked via the Internet can be avoided.

Further, for example, as for an OS that should be used outside the office, in the case where the OS is attempted to be used outside the office, the communication with another device is permitted, and in the case where the OS is attempted to be used in the office, the communication with another device is limited. For example, in the case where the PC is infected with a virus via a network such as the Internet while using outside the office the OS that should be used outside the office, and when attempting to connect to an in-company intranet or the like using the OS, the risk of the virus with which the PC is infected being spread via the intranet in the office can be avoided.

The present application contains subject matter related to that disclosed in Japanese Priority Patent Application JP 2010-034914 filed in the Japan Patent Office on Feb. 19, 2010, the entire content of which is hereby incorporated by reference.

What is claimed is:

1. An information processing apparatus comprising:
a first environment group information-management section which manages a first environment group including an operating system executed in a first environment;
a communication information-management section which manages first communication capability information which is set to communication-capable information indicating that communication with another device is possible or communication-incapable information indicating that the communication with such another device is not possible;
a determination processing section which determines at a predetermined timing whether or not the information processing apparatus is used in the first environment, which sets the first communication capability information managed by the communication information-management section to the communication-capable information when the determination processing section determines that the information processing apparatus is used in the first environment, and which sets the first communication capability information managed by the communication information-management section to the communication-incapable information when the determination processing section determines that the information processing apparatus is not used in the first environment; and
a communication control section which controls communication with such another device performed by an operating system execution section which executes the operating system included in the first environment group, based on the first communication capability information managed by the communication information-management section.

2. The information processing apparatus according to claim 1, further comprising
a determination information-management section which manages, when a connection request is received from a device used in the first environment, determination server-identification information for identifying a determination server that establishes a connection with the device,
wherein the determination processing section transmits a connection request to the determination server identified by the determination server-identification information managed by the determination information-management section, determines that the information processing apparatus is used in the first environment when a connection with the determination server is established, and determines that the information processing apparatus is not used in the first environment when the connection with the determination server is not established.

3. The information processing apparatus according to claim 1, further comprising
a determination information-management section which manages first internal gateway device-identification information for identifying a first internal gateway device that is present in the first environment and first external gateway device-identification information for identifying a first external gateway device that is present in a predetermined environment other than the first environment,
wherein, when the determination processing section transmits a routing information-acquiring packet to an external device that is present in the predetermined environment other than the first environment, and a response packet with respect to the routing information-acquiring packet includes routing information indicating a route which the routing information-acquiring packet passed through, the determination processing section determines that the information processing apparatus is used in the first environment when both the first internal gateway device-identification information and the first external gateway device-identification information are included in the routing information, and determines that the information processing apparatus is not used in the first environment when at least one of the first internal gateway device-identification information and the first external gateway device-identification information is not included in the routing information.

4. The information processing apparatus according to claim 1, further comprising
a determination information-management section which manages being-inside-first environment-determining information set in a first transfer packet which is being transferred in the first environment,
wherein the determination processing section determines that the information processing apparatus is used in the first environment when the being-inside-first environment-determining information is set in a reception packet, and determines that the information processing apparatus is not used in the first environment when the being-inside-first environment-determining information is not set in the reception packet.

5. The information processing apparatus according to claim 1, further comprising
a determination information-management section which manages first environment-position information indicating a position of the first environment,
wherein the determination processing section acquires current position information indicating a position at which the information processing apparatus is currently present, determines that the information processing apparatus is used in the first environment when the acquired current position information corresponds to the first environment-position information managed by the determination information-management section, and determines that the information processing apparatus is not used in the first environment when the acquired current position information does not correspond to the first environment-position information managed by the determination information-management section.

6. The information processing apparatus according to claim 1,
wherein, when a connection request is output to such another device from the operating system execution section which executes the operating system included in the first environment group, the communication control section establishes a connection with such another device when the first communication capability information managed by the communication information-management section is set to the communication-capable information, and outputs information indicating that the connection with such another device is not possible to the operating system execution section which executes the operating system included in the first environment group when the first communication capability information managed by the communication information-management section is set to the communication-incapable information.

7. The information processing apparatus according to claim 6,
wherein the first environment group information-management section manages the first environment group which further includes a communication control information-management section that manages VPN server-identification information for identifying a VPN server, and
wherein, when the connection request output from the operating system execution section which executes the operating system included in the first environment group is aimed at the VPN server identified by the VPN server-identification information managed by the communication control information-management section included in the first environment group, the communication control section establishes a connection with the VPN server even when the first communication capability information managed by the communication information-management section is set to the communication-incapable information.

8. The information processing apparatus according to claim 1,
wherein, when the operating system execution section which executes the operating system included in the first environment group is connected to such another device, the communication control section maintains a connection with such another device when the first communication capability information managed by the communication information-management section is set to the communication-capable information, and disconnects the connection with such another device when the first communication capability information managed by the communication information-management section is set to the communication-incapable information.

9. The information processing apparatus according to claim 8,
wherein the communication control section outputs information indicating that the connection with such another device is disconnected to the operating system execution section which executes the operating system included in the first environment group when the first communication capability information managed by the communication information-management section is set to the communication-incapable information.

10. The information processing apparatus according to claim 8,
wherein, when the operating system execution section which executes the operating system included in the first environment group is connected to such another device, the first environment group information-management section manages the first environment group which further includes disconnection processing-type information which is set to information indicating that the connection with such another device is to be maintained or information indicating that the connection with such another device is to be disconnected, and
wherein, when the first communication capability information managed by the communication information-management section is set to the communication-incapable information, the communication control section maintains the connection with such another device when the disconnection processing-type information included in the first environment group is set to the information indicating that the connection with such another device is to be maintained, and disconnects the connection with such another device when the disconnection processing-type information included in the first environment group is set to the information indicating that the connection with such another device is to be disconnected.

11. The information processing apparatus according to claim 8,
wherein the first environment group information-management section manages the first environment group which further includes VPN server-identification information for identifying a VPN server, and
wherein, when a connection destination of the operating system execution section which executes the operating system included in the first environment group is the VPN server identified by the VPN server-identification information included in the first environment group, the communication control section maintains a connection with the VPN server even when the first communication capability information managed by the communication information-management section is set to the communication-incapable information.

12. The information processing apparatus according to claim 1, further comprising
an outside-environment group information-management section which manages an outside-environment group including an operating system executed outside the first environment,
wherein the communication information-management section further manages outside-environment communication capability information which is set to communication-capable information indicating that the communication with such another device is possible or communication-incapable information indicating that the communication with such another device is not possible,
wherein the determination processing section sets the outside-environment communication capability information to the communication-incapable information when the determination processing section sets the first communication capability information managed by the communication information-management section to the communication-capable information, and sets the outside-environment communication capability information to the communication-capable information when the determination processing section sets the first communication capability information managed by the communication information-management section to the communication-incapable information, and
wherein the communication control section controls communication with such another device performed by an operating system execution section which executes the operating system included in the outside-environment group, based on the outside-environment communication capability information managed by the communication information-management section.

13. The information processing apparatus according to claim 1, further comprising:
a second environment group information-management section which manages a second environment group including an operating system executed in a second environment; and
an outside-environment group information-management section which manages an outside-environment group including an operating system executed outside the first environment,
wherein the communication information-management section further manages second communication capability information which is set to communication-capable information indicating that the communication with such another device is possible or communication-incapable information indicating that the communication with such another device is not possible, and also manages outside-environment communication capability information which is set to communication-capable information indicating that the communication with such another device is possible or communication-incapable information indicating that the communication with such another device is not possible,
wherein the determination processing section determines at the predetermined timing whether or not the information processing apparatus is used in the second environment, sets the second communication capability information managed by the communication information-management section to the communication-capable information when the determination processing section determines that the information processing apparatus is used in the second environment, sets the second communication capability information managed by the communication information-management section to the communication-incapable information when the determination processing section determines that the information processing apparatus is not used in the second environment, sets the outside-environment communication capability information to the communication-incapable information when the determination processing section sets at least one of the first communication capability information and the second communication capability information which are managed by the communication information-management section to the communication-capable information, and sets the outside-environment communication capability information to the communication-capable information when the determination processing section sets both the first communication capability information and the second communication capability information which are managed by the communication information-management section to the communication-incapable information, and
wherein the communication control section controls communication with such another device performed by an operating system execution section which executes the operating system included in the second environment group, based on the second communication capability information managed by the communication information-management section.

14. An information processing method performed by an information processing apparatus which includes a first environment group information-management section which manages a first environment group including an operating system executed in a first environment, a communication information-management section which manages first communication capability information which is set to communication-capable information indicating that communication with another device is possible or communication-incapable information indicating that the communication with such another device is not possible, a determination processing section, and a communication control section, the information processing method comprising the steps of:
determining, by the determination processing section, at a predetermined timing whether or not the information processing apparatus is used in the first environment;
setting, by the determination processing section, the first communication capability information managed by the communication information-management section to the communication-capable information when the determination processing section determines that the information processing apparatus is used in the first environment, and setting, by the determination processing section, the first communication capability information managed by the communication information-management section to the communication-incapable information when the determination processing section determines that the information processing apparatus is not used in the first environment; and
controlling, by the communication control section, communication with such another device performed by an operating system execution section which executes the operating system included in the first environment group, based on the first communication capability information managed by the communication information-management section.

15. A program for causing a computer to function as an information processing apparatus which includes
a first environment group information-management section which manages a first environment group including an operating system executed in a first environment,
a communication information-management section which manages first communication capability information which is set to communication-capable information indicating that communication with another device is possible or communication-incapable information indicating that the communication with such another device is not possible,
a determination processing section which determines at a predetermined timing whether or not the information processing apparatus is used in the first environment, which sets the first communication capability information managed by the communication information-management section to the communication-capable information when the determination processing section determines that the information processing apparatus is used in the first environment, and which sets the first communication capability information managed by the communication information-management section to the communication-incapable information when the determination processing section determines that the information processing apparatus is not used in the first environment, and
a communication control section which controls communication with such another device performed by an operating system execution section which executes the operating system included in the first environment group, based on the first communication capability information managed by the communication information-management section.
